(19) United States
(12) Patent Application Publication
(10) Pub. No.: US 2011/0165532 A1
(43) Pub. Date: Jul. 7, 2011

(54) Orthodontic Device with a Self-ligating Fixing System for Orthodontic Apparatuses with a Filiform Part, Related System and Orthodontic Kit

(75) Inventors: Marco Benvegnu', Thiene (VI) (IT); Bortolo Giuliano Maino, Vicenza (IT)

(73) Assignee: HDC S.R.L., Sarcedo (IT)

(21) Appl. No.: 12/837,871

(22) Filed: Jul. 16, 2010

(30) Foreign Application Priority Data
Jul. 27, 2009 (IT) VI2009A000191

(51) Int. Cl. A61C 7/00

(52) U.S. Cl. 433/18

(57) ABSTRACT

The invention relates to an orthodontic screw with a self-ligating fixing system for orthodontic apparatuses with a filiform part comprising a head equipped with at least one longitudinal slot for the insertion of said filiform part, a threaded shank to be applied to the bone of the mouth and a stop means to reversibly block said filiform part. The stop means is a fork comprising at least two teeth and the head features at least one through hole made in one of the walls which delimit the slot, and said hole has a corresponding second through or not through hole in the opposite wall delimiting the slot and in which the axis that runs through both holes is located above the filiform part insertable in said slot. In addition, the invention regards a related system and an orthodontic kit comprising said screw.

### FIELD OF THE INVENTION

The invention relates to an orthodontic device with a self-ligating fixing system for orthodontic apparatuses featuring a filiform part comprising a head with at least one longitudinal slot for the insertion of said filiform part and a threaded shank suited to be applied in the bone part of the mouth on which the head is placed, and a stop means to block the filiform part of the orthodontic apparatuses in the slot which is guided in such a way that it is reversibly positionable above the filiform part of the orthodontic apparatus insertable in said longitudinal slot blocking the filiform part in the closed condition against a vertical movement with respect to the longitudinal extension of said slot and allowing the filiform part to move vertically with respect to the longitudinal extension of said slot when it is open.

This description and the claims for orthodontic apparatuses assume that each device or part thereof, such as wires, plates, grids, fastenings, springs, elastics, anchoring elements, etc, is intended to correct dental malformations.

### BACKGROUND OF THE INVENTION

According to current orthodontic technology, one or more forces with pre-established intensity and directions are applied to the tooth to be treated to straighten it for aesthetic reasons or to improve the masticatory function.

The forces are transmitted to the tooth to be treated by means of orthodontic devices consisting of traction and/or pulling mechanical elements. A very important orthodontic device is a bracket, which is applied to a tooth. Usually, multiple brackets are applied to multiple teeth in the dental arch. These brackets are connected to each other by means of an orthodontic wire that passes through a channel or a slot that must be closed to prevent the wire from slipping out of it. Brackets or other orthodontic devices fastened to the teeth can be connected, for example, with wires, rubber bands and springs besides endosseous implants or mini-implants, TAD devices or screws or miniscrews driven into the alveolar, basal, palatine, zygomatic bone, etc. These screws act as anchors and have a shank that is threaded and screwed to the bone and an operating head equipped with means to screw and unscrew the screw itself and means to fasten it to orthodontic apparatuses.

Orthodontic screws are inserted into the bone through the soft tissues and have the part protruding from the gum or oral mucosa configured in such a way as to allow the application of devices for orthodontic treatment, including elastics, springs and orthodontic wires.

These screws can be in one piece and/or in two pieces, one represented by the part that is inserted into the bone and has a transmucosal portion and the other represented by the extraosseous portion fastenable to the former by screwing, with pressure on a conical base, with an interlocking effect and/or with an ancillary miniscrew.

Most traditional orthodontic screws allow the passage of the wire or other orthodontic apparatuses, but to lock it a manual intervention by the operator is necessary to fasten the orthodontic wire with a metal and/or elastic ligature to the screw head or to bend the wire around the screw to lock it or to apply a substance that locks it, such as a composite or a suitable resin, between the wire and the screw head itself.

This type of attachment by winding the wire or through the use of a second wire called ligation or with the use of other substances is time consuming and not very practical, especially if it must be done in areas that are inconvenient for the operator, e.g., the palate or molar areas. Sometimes there is the risk of the orthodontic wire slipping off the screw itself. This would involve the need to intervene again, causing considerable inconvenience to the patient.

The Italian patent application VI99A000241 describes a screw in which the operating head has an area with a smaller diameter than the overall diameter of a central cylindrical part of the operating head. But even in this case locking it is still impractical and requires winding the wire around the screw. Even the screw described in the document DE 10 200 606 A1 requires the use of additional material (rubber) to fasten a wire in the screw head.

Screws particularly suited to locking and releasing orthodontic wires without requiring additional auxiliary fasteners or elastic resins are described, for example, in the Italian patent application VI2008A000312 on behalf of the present applicant or in the document WO2008/045908 A2.

These orthodontic screws have the disadvantage that they secure the wire in the screw in such a way that it cannot slip out of the screw but which simultaneously allow the wire to slide through the slot. During the attachment of orthodontic devices sliding along the slot can be beneficial to better position the device, but sometimes it may be advantageous if in the final position the element does not move.

The orthodontic screw described in the document US 2009/0081614 A1 allows the insertion of a wire in slots in the screw head but does not accept rigid filiform parts in the slots so that these filiform parts come out of the slot horizontally.

Orthodontic screws proposed in the document WO 2007/049852 A2 allow the insertion of a filiform part in which the wire protrudes horizontally from the slot. The wire is fastened, for example, with an additional screw screwed into a central hole, which is located in the screw head, which implies a lateral positioning of the slot. The proposed plate closure requires the filiform part inserted in the slot to be free at least on one end in order to allow the insertion of the plate above the slot.

Known orthodontic screws are often necessary to fasten anchoring elements, like orthodontic plates, in the bone in the mouth where the screw shank is inserted into a hole in the plate and the plate is fastened with the pressure of the screw head on the surface of the plate, requiring the plate to be flat in the pressure zone.

### BRIEF SUMMARY OF THE INVENTION

The present invention aims to overcome all the drawbacks mentioned that are found in the known orthodontic screws.

In particular, the first object of the invention is to provide an orthodontic screw applicable in the bone part of the mouth so that they have self-ligating fixing systems for orthodontic apparatuses with a more simplified filiform part compared to the systems known to lock or unlock the orthodontic device, that is, to propose orthodontic screws with alternative self-ligating fixing systems for orthodontic apparatuses with a filiform part without using auxiliary fixing elements, such as elastics, resins etc.

A crucial objective is to provide an orthodontic screw with a fixing system for orthodontic apparatuses that allows the orthodontic apparatus to be locked in place and is also able to prevent, if required, the orthodontic device from sliding along its housing in the screw head.

Still another aim of the present invention is to provide orthodontic screws with a fixing system for orthodontic apparatuses, which makes the insertion or replacement of these orthodontic apparatuses easier and more convenient for the operator.

A further purpose of the invention is to provide an orthodontic system that ensures a secure, versatile and easily removable fastening of anchoring elements, particularly orthodontic plates, by means of orthodontic screws in the bone part of the mouth.

The aforementioned purposes are achieved by an orthodontic screw of the type mentioned at the beginning which is characterized in that the stop means is a fork comprising at least two teeth, and in that the head is equipped with at least one through hole in one of the walls that delimit the slot, and in that this hole is associated with a second through or non-through hole drilled in the opposite wall that delimits the slot and in which the axis running through those two holes is located above the filiform part insertable in the slot.

Advantageously, by simply and reversibly guiding the stop means above an orthodontic appliance inserted in the slot the same is easily locked or unlocked. The longitudinal slot may be straight but also curved or bent. The head may also contain more than one slot, the slots being parallel to or intersecting with each other. The cross section of the slot can be of any shape, for example, circular or rectangular. The design of the head can vary, that is, it is conceivable that the heads could have sections that are circular, rectangular, triangular, hexagonal, etc. The head and shank may be made in one piece. A second hole in the opposite wall allows better guidance of the stop means and offers housing to frame the fork in the second hole. The fork can be equipped with protruding elements, for example, that interlock behind the second hole preventing the fork from slipping out easily. The fork is easy to manufacture and easily installed without requiring auxiliary fixing or screwing elements. Forks have low production costs and can be made of different materials than the screw itself. The slot may be located centrally in the head.

The filiform part may for example be a part of orthodontic wires and/or clips and/or springs and/or plates and/or grids and/or orthodontic screws and/or orthodontic brackets.

In another variant of the invention, the head comprises at least one additional hole located in said walls vertically or horizontally next to an existing hole. The presence of at least two holes in a wall prevents the fork from sliding out in the direction of insertion as the fork bracket that connects the teeth of the fork is held by the part of the wall which is between the two holes. Preferably, for each tooth of the fork there is a pair of holes located on opposite walls. Adding a desired number of holes it is possible to create combinations of holes, each one of which represents a separate guide for each tooth. Depending on the configuration of the holes, the fork can be inserted, for example, with both teeth above the filiform part or with one tooth above and the other below said filiform part.

In a preferred construction variant of the invention for each of the two holes lying on opposite walls there is at least one second hole associated with it and placed vertically next to the other hole, and the fork has two divergent teeth that can be inserted in the vertical holes in the head in such a way that the filiform part is locked between the two teeth like in a pair of scissors.

According to another aspect of the invention, the head comprises a recess to accommodate one end of the fork so that it is concealed. That end may, for example, be the fork bracket that connects the teeth of the fork reducing its dimensions and thus creating less discomfort in the mouth.

Preferably, the fork has two teeth and is substantially “U”-shaped or the fork has three teeth and is substantially “E”-shaped. These are simple forms that block the filiform part in at least two points. In an advantageous construction variant of the three-toothed fork, the central tooth is shorter than the two outer teeth and has a curved tip, which in the closed condition rests on the filiform part. In this way the central tooth actually exerts a closing action, preventing the slipping of, for example, a wire inside the slot.

The invention achieves the goal of providing an orthodontic screw, which in addition to preventing the release of the orthodontic apparatus from the slot also prevents it from sliding into the slot. Particularly advantageous is an incremental increased thickness which facilitates the sliding of the fork over the orthodontic apparatus, making the opening and closing of the system easier. In another embodiment of the orthodontic screw according to the invention, the closure can be made active, as described above, if the two teeth of the fork are not parallel, but divergent, and if they are inserted in the vertical holes in the head in such a way that the filiform part is locked between the two teeth like in a pair of scissors. In this way the filiform part cannot slide along the slot.

Preferably, the fork has a hole that in the closed condition is accessible from the outside so as to allow the application of a tool to remove the fork.

In a highly preferred embodiment of the invention, the fork is suited to fasten a filiform part with an active closure in the respective slot in order to avoid the sliding of the filiform part along the slot. In this regard, the fork, advantageously, has an increased thickness in the area of contact with the filiform part. The increased thickness may be obtained as an inclined plane (e.g., a longitudinal, essentially triangular section of the tooth), a curved plane, which is a classic convexity, or even as a relief with a polygonal section. The increased thickness extends over the entire contact area or only a part of it. Preferably the increased thickness is obtained in an elastic form, using, for example, elastic materials. In the area of increased thickness the fork presses the filiform part against the bottom of the slot and thus ensures that it is completely locked also preventing the orthodontic apparatus from sliding inside the slot.

Advantageously, in their interaction the fork and head have at least one elastic retention mechanism that is directed so that it is coplanar with the fork and which can exert retention forces in a direction coplanar to the fork.

In a preferred embodiment of the invention, the fork is made of an elastic material and is equipped with interlocking means in the form of protrusions made in a coplanar form in the fork which after the insertion of the fork in the respective holes of the head interlock behind the holes. The insertion of the fork in the holes in the head occurs against the elastic force of the fork; when the teeth of the fork are inserted, thanks to its flexibility they move apart and the protrusions slide into place at the outlet of the respective hole behind it on its edges, thus preventing the release of the fork.

To make the screw even more flexible in the positioning and attachment of orthodontic apparatuses, the head may be connected in a detachable manner to the threaded shank. In another embodiment, the head is divided into an upper part comprising the slot and a removable bottom, which are detachable from each other. The detachability allows replacement of the head with another head that better suits the needs of orthodontic treatment without removing the shank from its location.

Another aspect of the invention relates to an orthodontic system that comprises an orthodontic screw according to the invention and an anchoring element for orthodontic devices comprising a plate with one or more elongated openings and arms with fixing means for the application of orthodontic devices in which at least one side of at least one of said openings is formed as a narrow band that is inserted as a filiform part in a slot of the orthodontic screw. In a preferred embodiment of this system, the narrow band of the anchoring element is a thin cross-piece that separates a pair of said elongated openings that are arranged side by side. These plate-shaped anchoring elements, that is, orthodontic plates, containing a narrow band join perfectly with an orthodontic screw according to the invention, as the narrow band can be reversibly inserted in the slot of the screw. The plate must be planar only in the part of the band lying in the slot, retaining the ability to deform the plate (to adapt it to the anatomical conditions in the mouth) in its other parts. The plate can be easily moved along the length of the narrow band within the slot of the screw. Thus this orthodontic system involves the use of the orthodontic screw according to the invention to insert the filiform part of the anchoring element (narrow band) in the slot. The shank of the screw allows the screw and thus the anchoring element to be fixed in the intraoral skeletal part.

Orthodontic screws according to the invention and relative anchoring elements can be combined in various forms and quantities in orthodontic kits.

Advantageously, the elongated openings are coupled with a second opening placed in such a manner that they form an appropriate angle (preferably around 90°) between their longitudinal extensions to fix the anchoring element firmly in two places in the mouth.

Preferably, the arms are placed on the perimeter of the plate. Preferably, the second fixing means for the application of orthodontic devices can be chosen from hooks and/or loops and/or pins and/or holes. An arm may also be an orthodontic grid.

Advantageously, the anchoring element is formed by one piece. However, an embodiment is also conceivable in which the anchoring element is formed by at least two elements connected to each other in a jointed manner.

Preferably, the orthodontic screw and the anchoring element are biocompatible to avoid compromising the health of the patient and so as not to be damaged by biological substances. Of course, the arms and/or second fixing means for the application of orthodontic devices may be the same or different from each other.

Metals are suitable materials for producing these orthodontic screws or anchoring elements, particularly titanium and its alloys (e.g., with nickel), as are other polymeric, ceramic, or composite materials. Particularly suitable are materials with a memory effect.

Preferably, the head is essentially cylindrical with a circular or polygonal or elliptical section. A polygonal or elliptical section has, for example, the advantage that the insertion of a loop of an orthodontic apparatus on the head slips off only if head and loop are perfectly overlapping.

Construction variants of the invention are the subject of the dependent claims.

### BRIEF DESCRIPTION OF THE DRAWINGS

The purpose and said advantages will be better highlighted in the description of preferred embodiments of the orthodontic device according to the invention which are given by way of a non-limiting example with reference to the attached drawings, wherein:

FIGS. 1a-c are perspective views of an example of embodiment of the orthodontic screw according to the invention illustrating the closing phases;

FIGS. 2a-d are side views of the orthodontic screw illustrated in FIGS. 1a-c, where FIGS. 2a and b represent the open condition and FIGS. 2c and d the closed condition;

FIGS. 3a-b are views from above of the orthodontic screw according to the invention represented in FIGS. 1a-c and 2a-d, where FIG. 3a shows the open condition and FIG. 3b shows the closed condition;

FIGS. 4a-b show another example of embodiment of the orthodontic screw illustrated in FIGS. 1a-c, 2a-d and 3a-b;

FIG. 5 shows an exploded side view of the orthodontic screw illustrated in FIGS. 1a-c, 2a-d and 3a-b in another example of embodiment;

FIGS. 6 and 7 show two further examples of embodiment of the orthodontic screw in a side view;

FIG. 8 shows how a fork locks a wire in the orthodontic screw;

FIGS. 9a-9e show a side view of an example of embodiment of the screw according to the invention, a corresponding top view in the open condition with a fork with three teeth, a corresponding top view in the closed condition, the respective fork and two possible examples of embodiment of the central tooth of the fork;

FIG. 10 shows a particularly preferred application of an orthodontic system according to the invention.

### DETAILED DESCRIPTION OF THE INVENTION

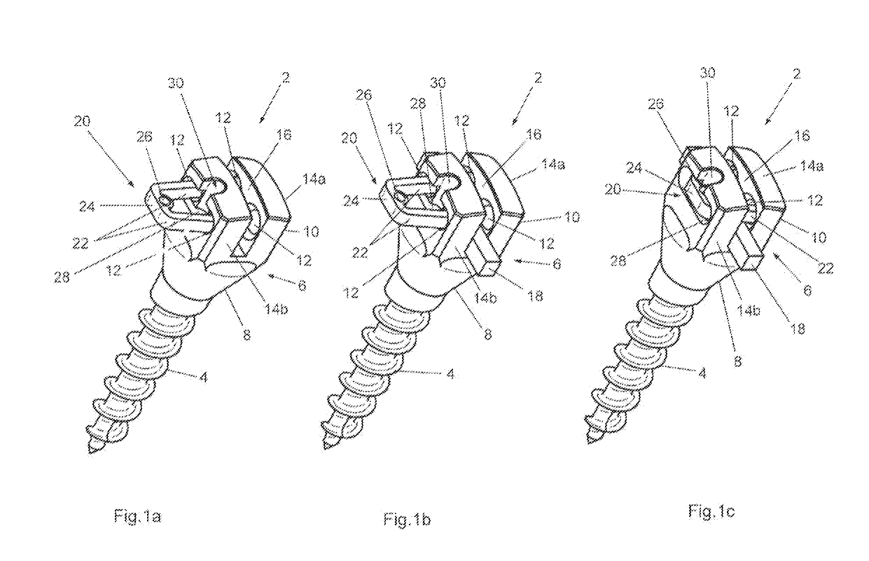

In the prospective views of FIGS. 1a-c an orthodontic screw is indicated as a whole by 2. The screw has a threaded shank 4 and an operating head 6. The operating head 6 is divided into a lower part 8 and an upper part 10. In an embodiment not represented in this document the operating head may consist of just the upper part. The lower part 8 of the example shown is conical, which facilitates its insertion into the gum. Other shapes are also conceivable, for example, a cylindrical shape. The upper part 10 has four holes 12. The holes are made in the walls 14a and 14b that delimit a slot 16 located in the operating head 6. The holes are arranged in pairs of holes essentially coinciding and opposite each other. The slot 16 houses an orthodontic apparatus 18, which in the case shown is an orthodontic wire. At the same time it works as a slot to insert a tool able to manoeuvre the head 6 and tighten the screw 2 in the oral cavity. In the embodiment shown herein, the fixing means are a fork 20 with two pin-shaped teeth 22. Said teeth 22 are insertable by sliding through a couple of opposing holes 12 from time to time. The fork 20 has a fork bracket 24 with a hole 26. The wall 14b comprises a longitudinal opening 28 parallel to the slot 16 in which the fork bracket 24 of the fork 20 disappears when the screw 2 is closed. The wall 14b is also provided with a channel 30, which extends parallel to the axis of the screw 2. The channel 30 is accessible from above and is connected to the opening 28. Advantageously, an operator can easily remove the fork 20 from the head 6 by inserting, for example, a pin through the channel 30 in the hole 26 and pulling the fork 20 out. It is clear that the shape of the holes 12 for the passage of the teeth 22 of the fork 20 may be circular, but does not necessarily have to be circular. Corresponding to the chosen shape of the fork 20 there are also other conceivable forms suited to allow the passage of the fork 20. In other examples of embodiment the fork may also have more than two teeth. Even the holes to conceal the fork in the screw head are many and easily adaptable by any person skilled in the art to the shape of the fork chosen. The same applies to the system that allows the extraction of the fork from the operating head to open the slot. Here it is conceivable that there are also protruding elements on the fork that can be grasped with suitable tools. The fork 20 of the embodiment shown is preferably comprised of material with elastic properties that allows the teeth 22 to be pressed toward one another during the insertion of the fork 20 in the head 6. Subsequent to the insertion they relax and cling to the edges of the holes 12 of the wall 14a. FIG. 1a shows the fixing device 2, that is, the screw in the open condition. In FIG. 1b an orthodontic wire 18 is inserted in the slot 16. In FIG. 1c the fork 20 is fully inserted into the operating head 6. The teeth 22 are located above the orthodontic wire 18 and prevent any vertical movement of the wire 18 in the slot 16. The body that forms the upper part of the operating head here is roughly cube-shaped, but may also be cylindrical or prismatic.

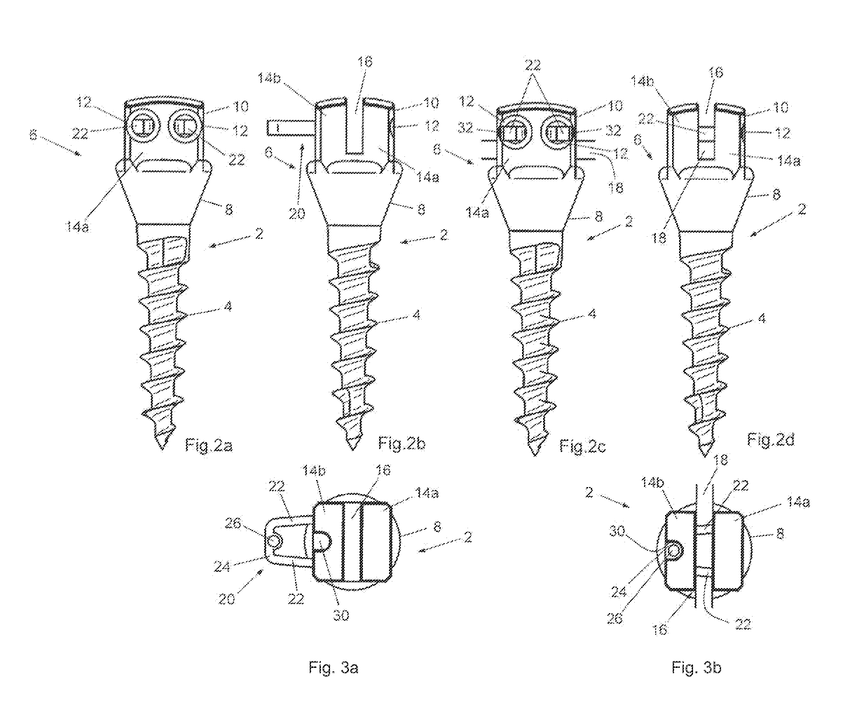

In FIGS. 2a-d the reference numbers correspond to those in FIGS. 1a-c. FIG. 2a represents the orthodontic screw 2 in a side view. The observer looks at the front of the wall 14a. Through the holes 12 the teeth 22 that do not yet close the slot 16 can be seen. FIG. 2b shows the same situation, but compared to FIG. 2a the screw 2 is rotated 90 degrees. The observer looks along the length of the slot 16. In FIG. 2c the fork 20 is fully inserted. The teeth 22 are located above an orthodontic wire 18 inserted in the slot 16. The wire 18 is blocked against any vertical movement. Advantageously, the tips of the teeth 22 are equipped with interlocking means 32 which protrude beyond the edge of the holes 12 and prevent the fork 20 from returning to the open position. The interlocking means may be of any type or be even absent. The interlocking means also prevent the loss of the fork 20 in the open position, fitting over the edges of the holes 12 of the wall 14b. FIG. 2d corresponds to the view of FIG. 2b; however, it shows the closed position of the screw 2.

FIGS. 3a and b show in the case of FIG. 3a the screw of the figures described above when in the open position and in the case of FIG. 3b in the closed position. The fork 20 in the open position leaves the slot 16 completely free. In the closed position the teeth 22 cover a wire 18 in the slot 16 blocking it. The fork bracket 24 is fully incorporated in the upper part 10 of the screw head 6 and makes the screw 2 less cumbersome. Given that the teeth 22 are not perpendicular to the fork bracket 24, the position of the holes can be chosen so that the opposing holes are not antipode, that is one is shifted slightly with respect to the other to take into account the obliquity of the teeth 22 with respect to the fork bracket 24. Of course, the teeth may also be parallel to each other and be inserted into holes that are fully aligned.

Orthodontic screw elements, which in their function and their characteristics correspond, with elements in a different embodiment, have the same reference numbers preceded by another digit to indicate the embodiment in question.

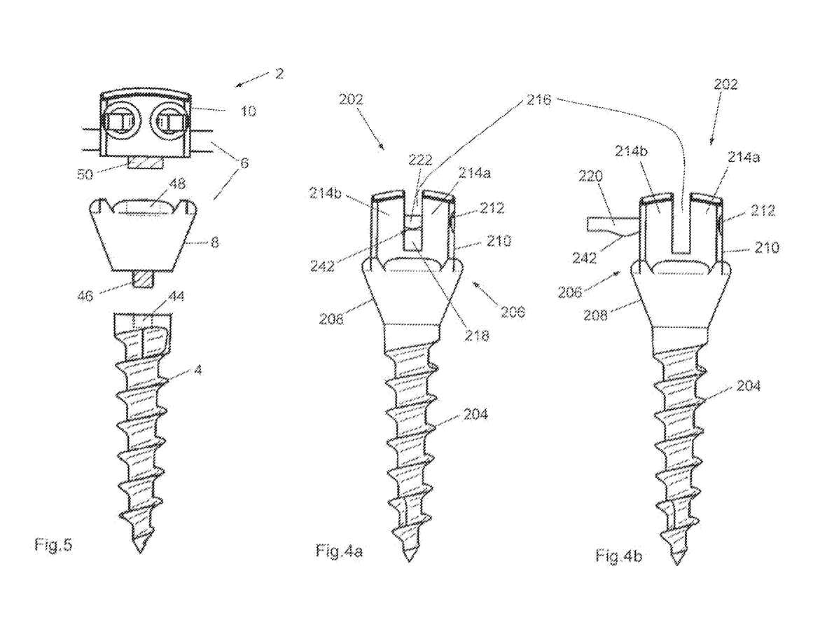

FIGS. 4a and b show the screws in FIGS. 1a-c, 2a-d and 3a-b with a new embodiment of the fork. With respect to FIGS. 1a-c, 2a-d and 3a-b in FIGS. 4a (closed) and 4b (closed) the fork has teeth 222 with a convex surface. This convex surface presses an orthodontic apparatus 218 inserted in the slot 216 against the bottom of the same. In this manner one objective of the invention is achieved: the orthodontic apparatus 218 is not only blocked and prevented from slipping out of the slot but is also prevented from sliding along the slot or at least a perfect housing for orthodontic wires with a square or rectangular section is obtained.

FIG. 5 illustrates an exploded side view of an example of embodiment of a screw 2 represented in FIGS. 1a-c, 2a-d and 3a-b. It shows how the screw can be made in order to be able to detach the various components. The threaded shank 4 is generally screwed into the bone, while the lower part 8 of the operating head 6 is located in the patient's gum. The upper part 10 protrudes from the gum. The lower part 8 is from time to time equipped with a threaded pin 46 which can be screwed into a corresponding threaded hole 44 drilled in the shank 4. Correspondingly, the upper part 10 may be equipped with a threaded pin 50 screwable into a corresponding threaded hole 48 located in the lower part 8. An orthodontic screw may feature both separability possibilities, between the upper and lower part and between the shank and the lower part or only one possibility. The coupling systems of the individual components are not limited to a screwing mechanism, all achievable coupling systems are considered, such as snap, friction systems etc. The coupling systems may also vary within a screw. The separability of the parts of the screw can be achieved for any screw according to the invention.

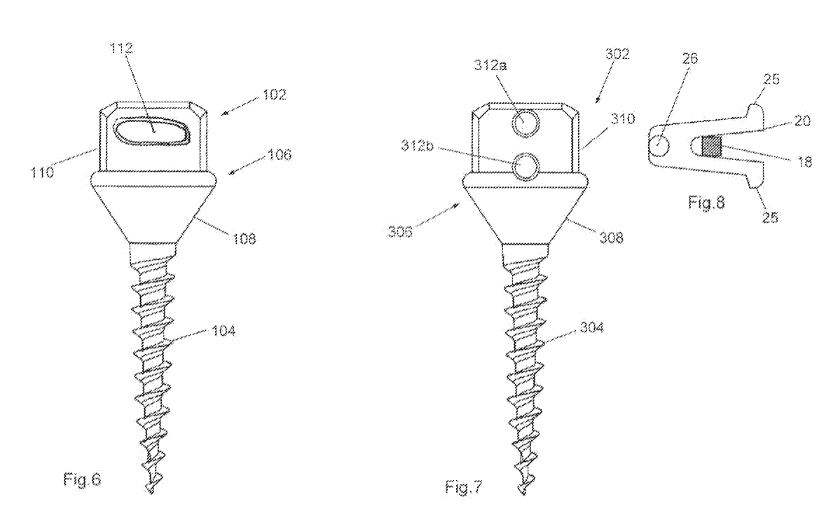

FIGS. 6 and 7 show screws 102 and 302, which compared to the first screw described above have in the case of FIG. 6 one hole 112 in a wall and in the second case two holes 312a and 312b placed one above the other. In the case of FIG. 6 the teeth of the fork pass through a single hole, while in the case of FIG. 7 the teeth of the fork are inserted above and below the wire. It is conceivable to make a single hole even in the vertical version.

FIG. 8 shows how the fork 20 blocks a wire 18. The tops of the pins of the fork that support the wire from above or below can be both or individually tilted. The interlocking means shall be identified with 25.

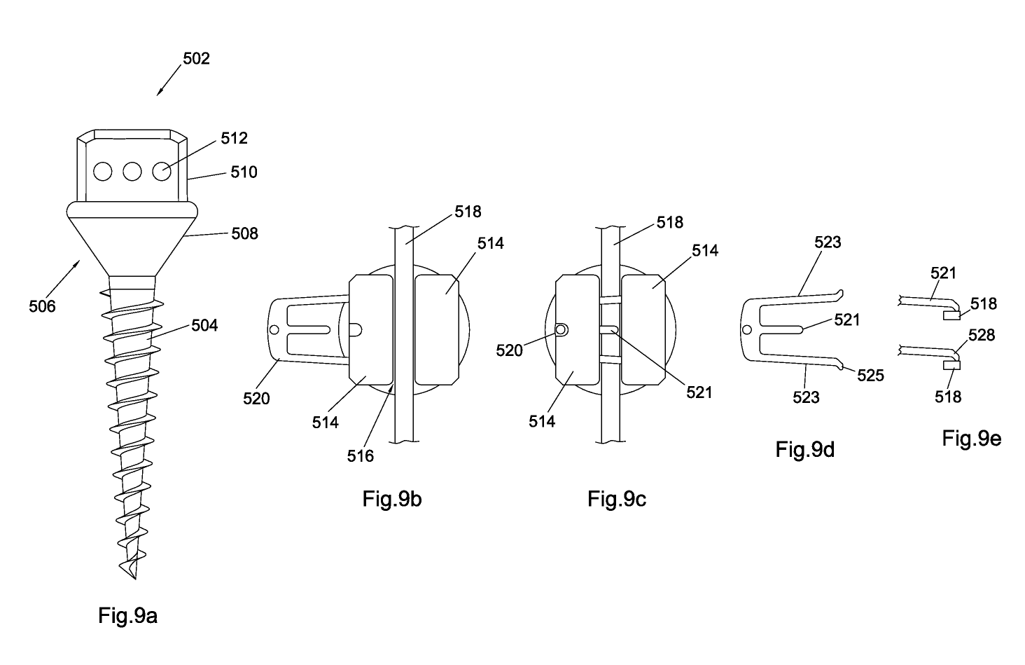

FIG. 9a shows a side view of an orthodontic screw 502 with three holes 512 arranged in a horizontal line in the head 506 (divided is in two parts 508 and 510). On the opposite wall one or two holes are enough to accommodate the two external teeth of the fork. The shank of the screw 504 is threaded. FIG. 9b shows a view from above of the filiform part 518 inserted in the slot 516 and the fork 520 not fully inserted in the head, while in FIG. 9c the fork 520 is completely inserted into the holes in the walls 514. FIG. 9d illustrates the “E”-shaped fork 520 featuring two side teeth 523 and a shorter central tooth 521. FIG. 9e shows two different curvatures of the central tooth 521, 528 and how the curved tip rests on the filiform part 518 when the screw is closed. The protrusions 525 of the fork work as interlocking means.

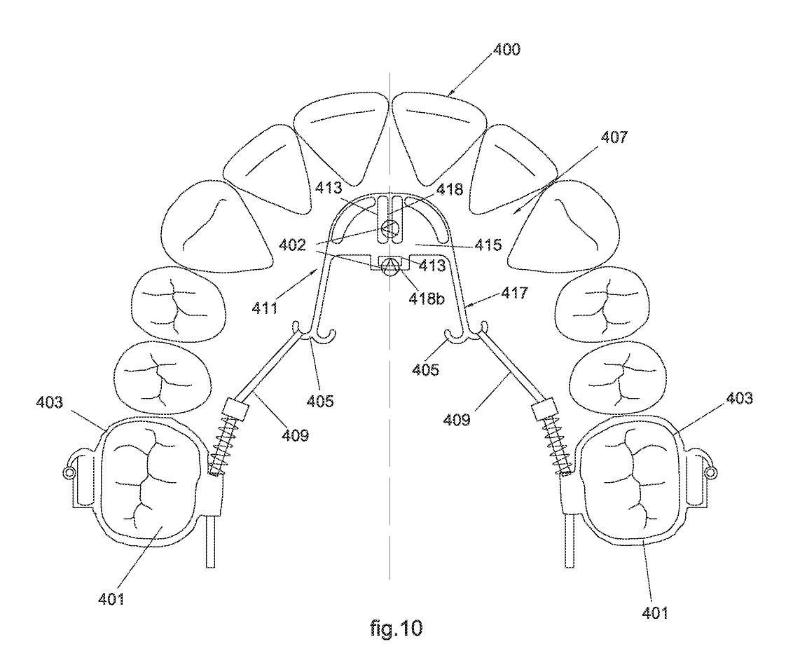

Finally, FIG. 10 shows a particularly preferred application of the invention. In a palate 407 orthodontic bands 403 were attached on two molars 401 of a dental arch 400. These bands are connected by orthodontic wires 409 to two hooks 405 of an anchoring element 411. The anchoring element 411 is fixed in the palate 407 with two screws 402 according to the invention. The screws 402 have in their slots respectively a crosspiece 418a and a narrow band 418b delimiting the buttonholes 413. The screws 402 are well suited to easily replace and insert the anchoring element. In case of failure of a screw, the simple opening of the remaining screw allows the anchoring element 411 to be shifted along, for example, the crosspiece 418a with no need to detach it and the subsequent insertion of a new screw in a suitable place. Where the head is detachable it can also be easily replaced with another orthodontic device to be screwed on the shank left on the palate.

Needless to say that in the lower part of the operating head there may be grooves or recesses to allow the passage of other orthodontic apparatuses, and this applies to all the examples of embodiment whether described or not.

In any embodiment of the invention the slots may have a rectangular section in order to prevent the rotation of orthodontic apparatuses with a rectangular section in the slot. Other section geometries are also possible, for example circular sections. The separability of the shank from the head is not limited to the embodiments described.

Given the information above, it is therefore understood that the orthodontic screw in all the embodiments described and shown effectively overcomes all the aforementioned problems that occur when known anchoring screws are used and provides simple alternative solutions to known screws.

In particular, it is understood that the new orthodontic screw featuring a self-ligating fixing system is a simple alternative for locking or unlocking orthodontic apparatuses without the use of auxiliary fasteners, such as elastics, resins etc.

The goal of providing an orthodontic screw that allows the locking of the inserted orthodontic apparatus and that can at the same time prevent the sliding of the orthodontic apparatus along its housing in the orthodontic device is also reached.

In addition, the invention provides a screw that makes the insertion or replacement of orthodontic apparatuses easy and convenient for the operator.

Moreover, the invention provides an orthodontic system consisting of an orthodontic screw and a plate-shaped anchoring element that requires no pressure on the plate surface to close but allows the simple fixing of a filiform part made in the plate to the slot of the screw while retaining the ability to deform the plate to adapt it to the anatomy of the mouth.

If in the construction stage the orthodontic screw, the orthodontic system and the orthodontic kit according to the invention are subjected to modifications that are such as to fall within the scope of the claims that follow, such modifications and variants must all be considered protected by this patent.

1. Orthodontic screw provided with a self-ligating fixing system for orthodontic apparatuses with a filiform part, comprising:
a head provided with at least one longitudinal slot for the insertion of said filiform part and a threaded shank that can be applied to the bone part of the mouth on which said head is located, and
a stop means for blocking said filiform part of said orthodontic apparatuses in said slot, guided in such a way that it can be reversibly located on said filiform part of said orthodontic apparatus, which can be inserted in said longitudinal slot, so that when it is closed it locks said filiform part against a vertical movement with respect to the longitudinal extension of said slot and when it is open it allows said filiform part to move vertically with respect to the longitudinal extension of said slot, wherein said stop means is a fork comprising at least two teeth and in that said head is provided with at least one through made in one of the walls that delimit the slot, and in that said hole is associated with a second through or not through hole made in the opposite wall that delimits the slot, and wherein the axis that runs through said two holes is above said filiform insertable in said slot.

2. Orthodontic screw according to claim 1, wherein said head comprises at least one further hole located in one of said walls vertically or horizontally beside an already existing hole.

3. Orthodontic screw according to claim 2, wherein each one of two holes, located on opposite walls, is associated with at least one further hole arranged vertically beside the other hole, and in that the fork has two diverging teeth insertable in said vertical holes made in said head so that the filiform part is locked between the two teeth like in a pair of scissors.

4. Orthodontic screw according to claim, wherein said fork has two teeth and is substantially U-shaped.

5. Orthodontic screw according to claim 1, wherein said fork has three teeth and is substantially E-shaped.

6. Orthodontic screw according to claim 5, wherein the centre tooth is shorter than the two outer teeth and has a curved tip that in the closed condition rests on the filiform part.

7. Orthodontic screw according to claim 1, wherein said fork is suited to fix a filiform part with active closure in the corresponding slot in order to prevent the filiform part from sliding along the slot.

8. Orthodontic screw according to claim 7, wherein said fork is thicker in the area of contact with the filiform part.

9. Orthodontic screw according to claim 1, wherein said fork and said head in their interaction have at least one elastic retention mechanism oriented so that it is coplanar with the fork and is capable of exerting retention forces in a direction coplanar to the fork.

10. Orthodontic screw according to claim 9, wherein said fork is made of an elastic material and is provided with interlocking means in the shape of protrusions created with coplanar shape in the fork, and in that said protrusions after the insertion of said fork in the corresponding holes in the head interlock behind the holes.

11. Orthodontic screw according to claim 1, wherein said head is connected to said threaded shank in a detachable manner.

12. Orthodontic screw according to claim 1, wherein said head is divided in an upper part comprising said slot and in a lower part that can be detached from each other.

13. Orthodontic system comprising an orthodontic screw, according to claim 1, and an anchoring element for orthodontic devices comprising a plate with one or more elongated openings, arms with fixing means for the application of orthodontic devices in which at least one side of at least one of said openings is formed as a narrow band inserted as a filiform part in a slot of the orthodontic screw.

14. System according to claim 13, wherein said narrow band of said anchoring element is a thin cross-piece that separates a pair of said elongated openings that are arranged side by side.

15. Orthodontic kit comprising an orthodontic screw, according to claim 1, and an anchoring element for orthodontic devices comprising a plate with one or more elongated openings, arms with fixing means for the application of orthodontic devices in which at least one side of at least one of said openings is formed as a narrow band.
